(19) United States
(12) Patent Application Publication
(10) Pub. No.: US 2012/0164470 A1
(43) Pub. Date: Jun. 28, 2012

(54) SILVER-NICKEL CORE-SHEATH NANOSTRUCTURES AND METHODS TO FABRICATE

(75) Inventors: Kurtis Leschkies, Santa Clara, CA (US); Roman Gouk, San Jose, CA (US); Steven Verhaverbeke, San Francisco, CA (US); Robert Visser, Menlo Park, CA (US)

(73) Assignee: APPLIED MATERIALS, INC., Santa Clara, CA (US)

(21) Appl. No.: 13/331,870

(22) Filed: Dec. 20, 2011

Related U.S. Application Data
(60) Provisional application No. 61/427,751, filed on Dec. 28, 2010.

(51) Int. Cl. B32B 15/01; C23C 28/00; C25D 3/50; B82Y 30/00; B82Y 40/00

(52) U.S. Cl. 428/607; 205/85; 977/892; 977/762; 977/810

(57) ABSTRACT

Embodiments of the invention generally provide core-sheath nanostructures and methods for forming such nanostructures. In one embodiment, a method for forming core-sheath nanostructures includes stirring an aqueous dispersion containing silver nanostructures while adding a catalytic metal salt solution to the aqueous dispersion and forming catalytic metal coated silver nanostructures during a galvanic replacement process. The method further includes stirring an organic solvent dispersion containing the catalytic metal coated silver nanostructures dispersed in an organic solvent while adding a nickel salt solution to the organic solvent dispersion, and thereafter, adding a reducing solution to the organic solvent dispersion to form silver-nickel core-sheath nanostructures during a nickel coating process. In one embodiment, the core-sheath nanostructures are silver-nickel core-sheath nanowires, wherein each silver-nickel core-sheath nanowire has a sheath layer of nickel disposed over and encompassing a catalytic metal layer of palladium disposed on a nanowire core of silver.

### CROSS-REFERENCE TO RELATED APPLICATION

This application claims benefit of U.S. Ser. No. 61/427,751 (APPM/015609L), entitled “Facile Synthesis of Silver-Nickel Core-Sheath Nanostructures”, filed Dec. 28, 2010, which is herein incorporated by reference in its entirety.

### BACKGROUND OF THE INVENTION

1. Field of the Invention

Embodiments of the invention generally relate to nanostructures, and more specifically, relate to core-sheath nanostructures and methods for forming such nanostructures.

2. Description of the Related Art

One-dimensional (1-D) nanostructures have received a great deal of attention over the past decade because of unique anisotropic structures and fascinating physical properties. Nanostructures show great promise in a wide range of applications such as electronics, photonics, sensing, imaging, drug delivery, as well as photovoltaic and solar applications. Metallic 1-D nanostructures, especially those made of silver, are attractive for use in the manufacturing of electronic and display devices due to their superior electrical and thermal conductivity as well as their ability to function as electromagnetic waveguides. However, the nanostructures must be manipulated and arranged over large areas when incorporated into many of the electronic and display devices. Methods have been developed to arrange the nanostructures into linear, cross, and other types of structural geometries, but such methods generally require complex equipment and/or materials.

Recently, there has also been an increasing interest for hybrid nanostructures which contain multiple materials integrated within each nanostructure. These multi-component nanostructures are attractive because of their increased functionality. By combining multiple materials into a single structure, the hybrid nanostructure generally has multiple desirable physical properties which are unattainable from the more traditional nanostructure containing a single material. Also, hybrid nanostructures containing bi- or multi-materials generally have additional handles for tailoring the desired properties which are unavailable in single material nanostructures.

Several types of multi-component nanostructures have been successfully synthesized, such as semiconductor nanostructures, metal-semiconductor core-sheath nanostructures, as well as semiconductor-metal hybrid nanostructures. In spite of some success at synthesizing the aforementioned multi-component nanostructures, most of these syntheses or systems cannot readily be applied to the production of 1-D, multi-metallic, core-sheath nanowires. Synthesis difficulties arise because of three primary reasons: i) the possibility for galvanic replacement reactions between two different metals; ii) the tendency for alloying between the metallic components; and iii) the lack of rough features or active sites on the surface of nanowires compared to the surface of nanoparticles. The latter reason leads to desirable homogeneous nucleation/growth on the surface of nanowires instead of heterogeneous nucleation/growth.

Nickel-plated silver nanowires have been previously synthesized using an anodic-aluminum oxide template procedure in conjunction with electrochemical deposition of nickel. However, the typical template procedure generally takes multiple steps which are time consuming and expensive. Also, the diameter size of the nanowires formed by the template procedure is limited due to the pore size of the template.

Therefore, there is a need for metallic nanostructures that can be easily manipulated without the need for excessive equipment, labor, or expense. There is also a need for a method for preparing such metallic nanostructures by a facile, robust procedure that can be utilized on a commercial-sized scale.

### SUMMARY OF THE INVENTION

Embodiments of the invention generally provide core-sheath nanostructures and methods for forming such nanostructures. Each of the core-sheath nanostructures have a nanostructure core of an electrically conductive metal (e.g., Ag or alloys thereof) coated with a catalytic metal layer (e.g., Pt, Pd, Au, or alloys thereof) and a sheath layer containing one or more ferromagnetic metals (e.g., Ni, Co, Fe, or alloys thereof). The ferromagnetic metal provides the core-sheath nanostructures with a magnetic property. Therefore, the core-sheath nanostructures may be easily manipulated by an outside magnetic field and magnetically aligned to form an optically transparent and electrically conductive thin film within a photovoltaic device. The optical transparency comes from the low density of metal in the thin film, which is a function of the diameter of the core-sheath nanostructures, as well as the line spacing between the core-sheath nanostructures.

In one embodiment, the core-sheath nanostructures are a plurality of core-sheath nanowires. Each of the core-sheath nanowires contains a nanowire core, a catalytic metal layer disposed on the nanowire core, and a sheath layer disposed over and encompassing the catalytic metal layer and the nanowire core. The nanowire core contains metallic silver and has a diameter within a range from about 5 nm to about 500 nm. The catalytic metal layer contains at least one metal selected from palladium, platinum, gold, alloys thereof, or combinations thereof and the sheath layer contains at least one ferromagnetic metal selected from nickel, cobalt, iron, alloys thereof, or combinations thereof. In some examples, the catalytic metal layer contains metallic palladium or metallic platinum and the sheath layer contains metallic nickel.

In another embodiment, a method for forming core-sheath nanostructures is provided and includes stirring an aqueous dispersion containing silver nanostructures while adding a catalytic metal salt solution to the aqueous dispersion and forming catalytic metal coated silver nanostructures during a galvanic replacement process. The catalytic metal coated silver nanostructures are removed or otherwise separated from the aqueous dispersion, washed, and centrifuged to remove any remaining contaminants. The method further includes forming an organic solvent dispersion containing the catalytic metal coated silver nanostructures dispersed in an organic solvent, stirring the organic solvent dispersion while adding a nickel salt solution to the organic solvent dispersion, and thereafter, adding a reducing solution to the organic solvent dispersion to form silver-nickel core-sheath nanostructures during a nickel coating process. The organic solvent generally contains a glycol, such as ethylene glycol. Subsequently, the silver-nickel core-sheath nanostructures are separated from the organic solvent dispersion, washed, and centrifuged to remove any remaining contaminants.

Each of the catalytic metal coated silver nanostructures has a layer or a partial layer of at least one catalytic metal disposed on a silver nanostructure. Exemplary catalytic metals include palladium, platinum, gold, alloys thereof, or combinations thereof. In some examples, the silver nanostructures are nanowires containing metallic silver, and each nanowire has a diameter within a range from about 5 nm to about 500 nm.

In some examples, the method further includes maintaining a predetermined or desirable Ag:Pd concentration ratio or Ag:Pt concentration ratio of the aqueous dispersion while adding the catalytic metal salt solution to the aqueous dispersion during the galvanic replacement process. The Ag:Pd or Ag:Pt concentration ratio may be within a range from about 400:1 to about 400:25 (16:1)—such as about 400:10 (40:1)—or within a range from about 600:25 (24:1) to about 200:25 (8:1)—such as about 400:25 (16:1)—while being combined during the galvanic replacement process. In some examples, the catalytic metal salt solution contains a tetrachloroplatinate salt or a tetrachloropalladate salt, such a potassium tetrachloroplatinate or potassium tetrachloropalladate.

In other examples, the method further includes maintaining a predetermined or desirable Ag:Ni concentration ratio of the organic solvent dispersion while adding the nickel salt solution to the organic solvent dispersion during the nickel coating process. The Ag:Ni concentration ratio may be within a range from about 400:200 to about 400:300 during the nickel coating process. The nickel salt solution may contain a nickel acetate salt, such as nickel acetate tetrahydrate, and further contain a capping agent or a surfactant, such as poly(vinylpyrrolidone). Subsequently, the method includes adding the reducing solution to the combined the nickel salt solution and organic solvent dispersion. In some examples, the reducing solution contains a hydrazine (e.g., hydrazine monohydrate) and a glycol (e.g., ethylene glycol).

In one embodiment, a method for forming core-sheath nanowires is provided and includes stirring an aqueous dispersion containing silver nanowires while adding a palladium salt solution to the aqueous dispersion and forming palladium coated silver nanowires during a galvanic replacement process. The palladium coated silver nanowires are removed or otherwise separated from the aqueous dispersion, washed, and centrifuged to remove any remaining contaminants. The method further includes forming an organic solvent dispersion containing the palladium coated silver nanowires dispersed in an organic solvent, stirring the organic solvent dispersion while adding a nickel salt solution to the organic solvent dispersion, and thereafter, adding a reducing solution to the organic solvent dispersion to form silver-nickel core-sheath nanowires during a nickel coating process. The silver-nickel core-sheath nanowires are removed or otherwise separated from the organic solvent dispersion, washed, and centrifuged to remove any remaining contaminants.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1B depict a multi-metallic core-sheath nanostructure, as disclosed by embodiments described herein.

FIG. 2 depicts a transmission electron microscopy (TEM) image of the multi-metallic core-sheath nanostructure depicted in FIGS. 1A-1B.

### DETAILED DESCRIPTION

Embodiments of the invention generally provide multi-metallic core-sheath nanostructures, such as nanowires, and methods for fabricating such multi-metallic core-sheath nanostructures. Each of the multi-metallic core-sheath nanostructures have a nanostructure core of an electrically conductive metal (e.g., Ag) coated with a catalytic metal layer (e.g., Pt, Pd, or Au) and a sheath layer containing one or more ferromagnetic metals (e.g., Ni, Co, Fe, or alloys thereof). The ferromagnetic metal provides the core-sheath nanostructures with a magnetic property. Therefore, the core-sheath nanostructures may be easily manipulated by an outside magnetic field and magnetically aligned to form an optically transparent and electrically conductive thin film within a photovoltaic device.

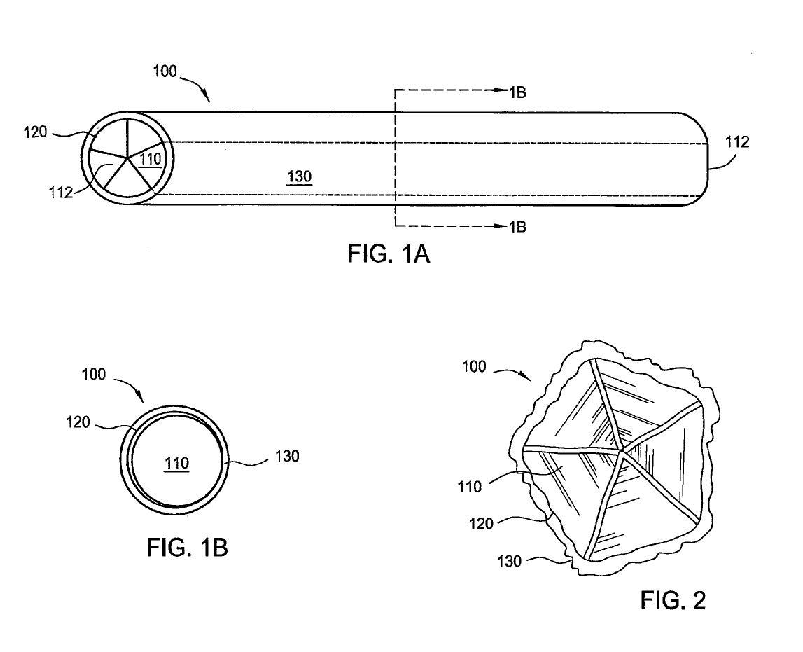

FIGS. 1A-1B depict core-sheath a nanowire 100 containing nanowire a core 110, a catalytic metal layer 120 disposed on a nanowire core 110, and a sheath layer 130 disposed over and encompassing catalytic metal layer 120 and nanowire core 110, as described by embodiments herein. FIG. 1A depicts core-sheath nanowire 100 as an exemplary multi-metallic core-sheath nanostructure that may be fabricated or otherwise formed by methods described herein. Other multi-metallic core-sheath nanostructures that may be formed by methods described herein include nanorods, nanoribbons, and nanoparticles. Core-sheath nanowire 100 is generally a multi-metallic core-sheath nanowire, which has nanowire core 110 containing metallic silver.

FIG. 1A depicts core-sheath nanowire 100 as having a substantially cylindrical geometry. The cross-sectional view of core-sheath nanowire 100, as depicted in FIG. 1B, illustrates the width of core-sheath nanowire 100 has a circular geometry or a substantially circular geometry along the perimeter. However, the width of core-sheath nanowire 100, as well as other multi-metallic core-sheath nanostructures, may also have a less circular but rounded geometry, such as ellipsoidal, elliptical, oval, elongated, or having one or multiple sides about the diameter or width. A multi-sided structured geometry extending across the width or the diameter of core-sheath nanowire 100 is indicative of a specific metal having a crystalline metallic lattice within nanowire core 110. Exemplary multi-sided structured geometries include rectangular, pentagonal, hexagonal, heptagonal, octagonal, and higher ordered multi-sided structured geometries. FIG. 2 illustrates a cross-sectional view of a transmission electron microscopy (TEM) image of core-sheath nanowire 100. The TEM image reveals a pentagonal structured geometry across the width or the diameter of core-sheath nanowire 100. The pentagonal structured geometry is indicative of a crystalline silver lattice contained within nanowire core 110. The silver nanowires utilized as nanowire core 110 have been characterized with pentagonal cross sections, originating from the elongation of the five-fold multiple twinned seeds along the common axes.

FIG. 1A depicts an end cap 112 disposed on opposite ends of core-sheath nanowire 100. The length of core-sheath nanowire 100 extends between the two end caps 112. End cap 112 may have a variety of geometries depending on the composition and crystalline state of exposed surfaces of core-sheath nanowire 100. End cap 112 generally contains portions of nanowire core 110, catalytic metal layer 120, and sheath layer 130.

Nanowire core 110 is depicted as a nanowire but may be another nanostructure, such as a nanorod, a nanoribbon, or another nano-size scaled particle. Nanowire core 110 generally contains at least one highly conductive metal, such as metallic silver, silver alloys, or doped variants thereof. Also, the conductive metal contained within nanowire core 110 is generally crystalline, such as monocrystalline. In one example, nanowire core 110 is a nanowire containing crystalline, metallic silver.

Nanowire core 110 generally has a width or a diameter within a range from about 5 nm to about 500 nm, more narrowly within a range from about 20 nm to about 200 nm, more narrowly within a range from about 30 nm to about 150 nm, and more narrowly within a range from about 50 nm to about 100 nm, for example, about 70 nm. Nanowire core 110 generally has a length within a range from about 100 nm to about 20,000 nm (20 μm), more narrowly within a range from about 250 nm to about 5,000 nm (5 μm), more narrowly within a range from about 400 nm to about 2,000 nm (2 μm), or from about 500 nm to about 1,000 nm (1 μm), for example, about 750 nm. In some examples, nanowire core 110 has a length within a range from about 1,000 nm (1 μm) to about 10,000 nm (10 μm), more narrowly within a range from about 2,000 nm (2 μm) to about 8,000 nm (8 μm), and more narrowly within a range from about 4,000 nm (4 μm) to about 6,000 nm (6 μm), for example, about 5,000 nm (5 μm). Therefore, nanowire core 110 has an aspect ratio measured from length to width or length to diameter of nanowire core 110. The aspect ratio of nanowire core 110 is generally within a range from about 5:1 to about 50:1, such as about 10:1.

Catalytic metal layer 120 is a seed layer or a nucleation layer disposed on the surface of nanowire core 110. Catalytic metal layer 120 is plated, deposited, or otherwise formed on the surface of nanowire core 110. Generally, catalytic metal layer 120 has a crystalline state, such as a polycrystalline state and may extend discontinuously or continuously across the surface of nanowire core 110. In some examples, catalytic metal layer 120 contains clusters or islands of catalytic metal atoms extending discontinuously across nanowire core 110. In other examples, catalytic metal layer 120 is formed as a continuous layer on nanowire core 110, such as by a galvanic replacement process. During the galvanic replacement process, metallic atoms of a first element (e.g., Ag) contained on the surface of nanowire core 110 are chemically oxidized and removed as metallic ions of the first element while metallic ions of a second element (e.g., Pd, Pt, or Au) are chemically reduced and deposited as metallic atoms of the second element contained on the surface of nanowire core 110, hence a galvanic replacement reaction. The standard reduction potential between the metal/ion pair of the first element must be lower than the standard reduction potential between the metal/ion pair of the second element. Therefore, catalytic metal layer 120 is generally formed with no more than a single layer of catalytic metal atoms extending across nanowire core 110 by a galvanic replacement process.

Catalytic metal layer 120 contains one or more metals having the desirable properties of strong nucleation and adhesion, as well as being highly electrically conductive. Exemplary metals contained within catalytic metal layer 120 include palladium, platinum, gold, alloys thereof, doped variations thereof, derivatives thereof, or combinations thereof. In some examples, catalytic metal layer 120 contains palladium or a palladium alloy and discontinuously extends across the surface of nanowire core 110. In an alternative embodiment, catalytic metal layer 120 contains silver and at least one additional metal, such as a silver alloy material. Exemplary silver alloy materials include palladium-silver, platinum-silver, gold-silver, alloys thereof, doped variations thereof, derivatives thereof, or combinations thereof.

Sheath layer 130 is a smooth and uniform coating of core-sheath nanowire 100 and continuously extends and encompasses nanowire core 110 and catalytic metal layer 120. Sheath layer 130 is disposed, deposited, plated, or otherwise formed on and/over nanowire core 110 and catalytic metal layer 120. In some examples, sheath layer 130 is deposited by an electroless deposition process. Sheath layer 130 contains one or more ferromagnetic materials or metals such as nickel, cobalt, iron, alloys thereof, doped variations thereof, derivatives thereof, or combinations thereof.

The ferromagnetic material provides core-sheath nanowire 100 with a magnetism property. Therefore, core-sheath nanowires 100 coated with sheath layer 130 containing the ferromagnetic material may be easily manipulated by an outside magnetic field and magnetically aligned to form a network of core-sheath nanowires 100. Such network of core-sheath nanowires 100 is an optically transparent and electrically conductive thin film which may be utilized in many solar and photovoltaic applications and devices.

Sheath layer 130 generally has a thickness within a range from about 0.5 nm to about 50 nm, more narrowly within a range from about 1 nm to about 30 nm, from about 2 nm to about 20 nm, or from about 3 nm to about 10 nm, for example, about 5 nm. Sheath layer 130 may have a thickness within a range from about 5% to about 15%, such as about 10%, of the diameter or the thickness of nanowire core 110. In some examples, sheath layer 130 contains nickel or a nickel alloy and is deposited to a thickness of about 5 nm by an electroless deposition process.

The desirable length and width of core-sheath nanowire 100 is dictated by the specific application utilizing core-sheath nanowire 100. Core-sheath nanowire 100 generally has a length within a range from about 100 nm to about 20,000 nm (20 μm), more narrowly within a range from about 250 nm to about 5,000 nm (5 μm), more narrowly within a range from about 400 nm to about 2,000 nm (2 μm), and further more narrowly within a range from about 500 nm to about 1,000 nm (1 μm), for example, about 750 nm. In some applications, the length of core-sheath nanowire 100 is within a range from about 1,000 nm (1 μm) to about 10,000 nm (10 μm), more narrowly within a range from about 2,000 nm (2 μm) to about 8,000 nm (8 μm), and more narrowly within a range from about 4,000 nm (4 μm) to about 6,000 nm (6 μm), for example, about 5,000 nm (5 μm).

Core-sheath nanowire 100 generally has a width or a diameter within a range from about 10 nm to about 500 nm, more narrowly within a range from about 20 nm to about 200 nm, more narrowly within a range from about 30 nm to about 150 nm, and further more narrowly within a range from about 60 nm to about 100 nm, for example, about 75 nm. Therefore, core-sheath nanowire 100 has an aspect ratio measured from length to width or length to diameter of core-sheath nanowire 100. The aspect ratio of core-sheath nanowire 100 is generally within a range from about 5:1 to about 50:1, such as about 10:1.

The core-sheath nanowires 100 formed by methods described herein are utilized within photovoltaic, solar, or other electronic devices which contain p-type materials (e.g., p-doped silicon-containing materials). The specific ferromagnetic material contained within sheath layer 130 may be dependent on the desired use of the core-sheath nanowires 100 and the work-function value of the ferromagnetic material. The work-function of nickel is greater than the work-function of cobalt and therefore nickel is more favorable to match p-type materials than cobalt. Additionally, the work-function of cobalt is greater than the work-function of iron and therefore cobalt is more favorable to match p-type materials than iron. Therefore, in some applications of core-sheath nanowires 100, sheath layer 130 contains nickel or a nickel alloy while in other applications, sheath layer 130 contains cobalt or a cobalt alloy.

Core-sheath nanowire 100 includes nanowire core 110 containing metallic silver or a silver alloy, catalytic metal layer 120 containing metallic palladium, a palladium alloy, metallic platinum, or a platinum alloy, metallic gold, or a gold alloy, and sheath layer 130 containing a ferromagnetic material, such as metallic nickel, a nickel alloy, metallic cobalt, a cobalt alloy, metallic iron, an iron alloy, or combinations thereof. In some examples, core-sheath nanowire 100 is a silver-nickel core-sheath nanowire and includes nanowire core 110 containing metallic silver or a silver alloy, catalytic metal layer 120 containing metallic palladium, a palladium alloy, metallic platinum, or a platinum alloy, and sheath layer 130 containing metallic nickel or a nickel alloy. The exemplary silver-nickel core-sheath nanowire generally has total diameter of about 80 nm and includes a nanowire core with a diameter of about 70 nm and a sheath layer with a thickness of about 5 nm encompassing the nanowire core and the catalytic metal layer.

### Exemplary Method for Forming Core-Sheath Nanostructures

In one embodiment, a plurality of multi-metal core-sheath nanostructures are fabricated by methods described herein In some examples, each core-sheath nanostructure is a silver-nickel core-sheath nanowire, such as core-sheath nanowire 100 that has a catalytic material, such as catalytic metal layer 120, disposed on a silver nanostructure core, such as nanowire core 110, and nickel ferromagnetic layer, such as sheath layer 130, disposed on or over catalytic metal layer 120 and nanowire core 110.

A dispersion containing silver nanostructures is formed and stirred while a catalytic metal salt solution is added to the dispersion. The dispersion may be an aqueous dispersion, an organic solvent dispersion, or mixtures thereof. The dispersion contains the silver nanostructures dispersed within a solvent, such as water, an alcohol (e.g., methanol, ethanol, propanol), a glycol (e.g., ethylene glycol, propylene glycol, butylene glycol), a glycol ether (e.g., ethylene glycol monomethyl ether, ethylene glycol monoethyl ether), other organic solvents (e.g., acetone, methyl ethyl ketone, ethyl ether, tetrahydrofuran, pentane, hexane, heptane, benzene, toluene), derivatives thereof, or mixtures thereof. In one example, the dispersion is an aqueous dispersion containing silver nanostructures dispersed in water. In another example, the dispersion is an organic solvent dispersion containing silver nanostructures dispersed in an alcohol, such as ethanol, or a glycol, such as ethylene glycol. In another example, the silver nanostructures are dispersed in a mixture of water and alcohol, such as 50% by volume ethanol in water.

The dispersion containing the silver nanostructures is heated and maintained at a temperature from about 40° C. to about 120° C., more narrowly within a range from about 50° C. to about 110° C., and more narrowly within a range from about 60° C. to about 100° C., for example, about 65° C. or about 95° C. for a time period within a range from about 5 minutes to about 10 minutes. Subsequently, a catalytic metal salt solution is added, usually dropwise, into the dispersion to galvanically replace silver atoms on the surface of the silver nanostructures with catalytic metal atoms, such as palladium, platinum, or gold. Catalytic metal coated silver nanostructures are formed from the silver nanostructures as a catalytic metal layer is formed thereon during the galvanic replacement process. The catalytic metal layer may be a discontinuous layer or a continuous layer and contains one or more catalytic metals. Exemplary catalytic metals include palladium, platinum, gold, alloys thereof, doped variations thereof, derivatives thereof, or combinations thereof.

In some embodiments, the catalytic metal salt solution may be added to the aqueous dispersion at a rate to maintain a Ag:Pd concentration ratio or a Ag:Pt concentration ratio of the aqueous dispersion within a range from about 400:1 to about 400:25 (16:1)—such as about 400:10 (40:1)—during the galvanic replacement process. In other embodiments, the catalytic metal salt solution may be added to the aqueous dispersion at a rate to maintain a Ag:Pd concentration ratio or a Ag:Pt concentration ratio of the aqueous dispersion within a range from about 600:25 (24:1) to about 200:25 (8:1)—such as about 400:25 (16:1)—during the galvanic replacement process.

In some examples, a tetrachloropalladate solution was added dropwise into the dispersion of silver nanostructures while maintaining a Ag:Pd concentration ratio of about 400:1. In other examples, the Ag:Pd concentration ratio was maintained at about 400:10 (40:1) or about 400:25 (16:1). The tetrachloropalladate solution may be an aqueous solution having a concentration of a tetrachloropalladate salt within a range from about 0.05 mM to about 0.5 mM, such as about 0.2 mM in water. The tetrachloropalladate salt may be potassium tetrachloropalladate (K₂[PdCl₄]), sodium tetrachloropalladate (Na₂[PdCl₄]), lithium tetrachloropalladate (Li₂[PdCl₄]), ammonium tetrachloropalladate ((NH₄)₂[PdCl₄]), hydrates thereof, derivatives thereof, or combinations thereof.

Alternatively, in some examples, a tetrachloroplatinate solution was added dropwise into the dispersion of silver nanostructures while maintaining a Ag:Pt concentration ratio of about 400:1. In other examples, the Ag:Pt concentration ratio was maintained at about 400:10 (40:1) or about 400:25 (16:1). The tetrachloroplatinate solution may be an aqueous solution having a concentration of a tetrachloroplatinate salt within a range from about 0.05 mM to about 0.5 mM, such as about 0.2 mM in water. The tetrachloroplatinate salt may be a tetrachloroplatinate salt may be potassium tetrachloroplatinate (K₂[PtCl₄]), sodium tetrachloroplatinate (Na₂[PtCl₄]), lithium tetrachloroplatinate (Li₂[PtCl₄]), ammonium tetrachloroplatinate ((NH₄)₂[PtCl₄]), hydrates thereof, derivatives thereof, or combinations thereof.

In other examples, a chloroauric acid (HAuCl₄) solution was added dropwise into the dispersion of silver nanostructures while maintaining a Ag:Au concentration ratio of about 425:25. The chloroauric acid solution may be an aqueous solution having a concentration of a tetrachloroplatinate salt within a range from about 0.05 mM to about 0.5 mM, such as about 0.3 mM in water.

The galvanic reaction was maintained stirring and at the predetermined temperature for a time period within a range from about 10 minutes to about 20 minutes, such as about 15 minutes. Subsequently, the catalytic metal coated silver nanostructures (e.g., Ag—Pd, Ag—Pt, Ag—Au nanostructures) were separated from the dispersion or aqueous solution by filtration. Thereafter, the catalytic metal coated silver nanostructures were washed in a mixture of ethanol and water and centrifuged at about 2,500 rpm for a time period within a range from about 2 minutes to about 20 minutes, more narrowly within a range from about 5 minutes to about 15 minutes, for example, about 10 minutes, to remove unreacted precursors.

A dispersion containing the catalytic metal coated silver nanostructures (e.g., Ag—Pd nanowires) is formed and stirred while a nickel salt solution is added to the dispersion during a nickel coating process. The dispersion is usually an organic solvent dispersion, but may also be an aqueous dispersion or a dispersion containing a mixtures of an organic solvent and water. The dispersion usually contains the catalytic metal coated silver nanostructures dispersed an organic solvent, such as a glycol (e.g., ethylene glycol, propylene glycol, butylene glycol). Alternatively, the dispersion may contain the catalytic metal coated silver nanostructures dispersed in other solvents, such as an alcohol (e.g., methanol, ethanol, propanol, butanol), a glycol ether (e.g., ethylene glycol monomethyl ether, ethylene glycol monoethyl ether), other organic solvents (e.g., acetone, methyl ethyl ketone, ethyl ether, tetrahydrofuran, pentane, hexane, heptane, benzene, toluene), water, derivatives thereof, or mixtures thereof. In one example, the dispersion is an organic solvent dispersion containing the catalytic metal coated silver nanostructures dispersed in ethylene glycol. During the nickel coating process, the dispersion is heated, stirred, and maintained at temperature from about 40° C. to about 120° C., more narrowly within a range from about 50° C. to about 110° C., more narrowly within a range from about 60° C. to about 100° C., for example, about 65° C. or about 95° C. for a time period within a range from about 2 minutes to about 20 minutes, more narrowly within a range from about 5 minutes to about 15 minutes, for example, about 10 minutes. In one example, the dispersion is heated and maintained at temperature of about 65° C. and stirred for about 10 minutes during the nickel coating process. In another example, the dispersion is heated and maintained at temperature of about 95° C. and stirred for about 5 minutes during the nickel coating process.

The nickel salt solution is added, usually dropwise, into the stirring dispersion of the catalytic metal coated silver nanostructures during an initial phase of the nickel coating process. The nickel salt solution contains a nickel salt or other nickel compound, a capping agent or a surfactant, and at least one solvent. The nickel salt may be nickel acetate, such nickel acetate tetrahydrate ((CH₃CO₂)₂Ni.4H₂O). The capping agent or the surfactant may be a polymeric surfactant/compound, such as poly(vinylpyrrolidone) (PVP). The capping agent generally forms strong bonds to the side surfaces of the silver nanostructures to facilitate anisotropic growth of the subsequent layer as well as to prevent aggregation of the silver nanostructures while in the dispersion. The capping agent may be a surfactant or a polymeric surfactant. Exemplary surfactants which may be used as a capping agent include poly(vinylpyrrolidone) (PVP), poly(vinyl alcohol) (PVA), cetyltrimethylammonium bromide (CTAB), cetyltrimethylammonium tosylate (CTAT), tetrabutylammonium bromide (TBAB), sodium dodecyl sulfate (SDS), dodecyl benzene sulfonic acid sodium (DBS), derivatives thereof, or combinations thereof.

The solvent contained within the nickel salt solution may be an organic solvent, water, or a mixtures of an organic solvent and water. Usually, the nickel salt solution contains an organic solvent such as a glycol (e.g., ethylene glycol (EG), propylene glycol, butylene glycol). In some examples, nickel salt solution contains nickel acetate tetrahydrate, PVP and EG. The concentration of the nickel salt may be within a range from about 5 mM to about 80 mM, more narrowly within a range from about 10 mM to about 40 mM, for example, about 17 mM. The concentration of the polymeric compound ay be within a range from about 25 mM to about 300 mM, more narrowly within a range from about 50 mM to about 150 mM, for example, about 94 mM. In some examples, nickel salt solution (about 17 mM of nickel acetate tetrahydrate and about 94 mM PVP in EG) was added dropwise into the dispersion of the catalytic metal coated silver nanostructures while maintaining a Ag:Ni concentration ratio within the range from about 400:200 to about 400:300 during the nickel coating process.

Nickel coated silver nanostructures are formed from the catalytic metal coated silver nanostructures during a second phase of the nickel coating process. Once the nickel salt solution has been added to the dispersion, a reducing solution is added, usually dropwise, to the dispersion during this second phase. The reducing solution chemically reduces the nickel ions from the nickel salts/compounds to form a metallic nickel surface disposed over the catalytic metal layers and the silver nanowire cores—such as silver-nickel core-sheath nanostructures. The reducing solution contains a reducing agent and a solvent. The reducing agent may include hydrazine, an alkyl hydrazine, ammonia, hydrates thereof, derivatives thereof, or combinations thereof. The solvent may be water, but usually is an organic solvent, such as a glycol or a glycol ether. Exemplary glycols useful as the reducing agent include ethylene glycol, propylene glycol, or butylene glycol. The reducing solution may have a volume ratio of the reducing agent to the solvent within a range from about 5:1 to about 15:1, such as about 9:1. In some examples, the reducing solution contains a hydrazine and a glycol, such as hydrazine hydrate (H₄N₂.H₂O) and EG. In one example, the reducing solution contains hydrazine monohydrate in EG at a volume ratio of hydrazine monohydrate:EG of about 1:9, and about 0.40 mL of the hydrazine solution was added dropwise into the dispersion.

After adding all of the hydrazine solution to the dispersion, the reaction mixture may be stirred for a time period within a range from about 10 minutes to about 30 minutes, such as about 20 minutes. Thereafter, the silver-nickel core-sheath nanostructures are formed and contained within the remnants of the reaction mixture/solution. The silver-nickel core-sheath nanostructures are removed or otherwise separated from the reaction solution. For example, the silver-nickel core-sheath nanostructures are separated from the reaction solution by filtration techniques or by using magnetic separation techniques, such as extracting the magnetic nanostructures by an external magnet.

Once separated from the reaction mixture, the silver-nickel core-sheath nanostructures are washed and/or centrifuged in one or multiple solvents to remove any remaining contaminants or unreacted chemical precursors. The solvents include water, an alcohol (e.g., methanol, ethanol, propanol), or other organic solvents (e.g., acetone, methyl ethyl ketone, ethyl ether, tetrahydrofuran, pentane, hexane, heptane, benzene, toluene), derivatives thereof, or mixtures thereof. In one example, the silver-nickel core-sheath nanostructures are washed in acetone and centrifuged at about 2,500 rpm for a time period within a range from about 5 minutes to about 20 minutes, such as about 10 minutes. Thereafter, the silver-nickel core-sheath nanostructures are washed in water and centrifuged at about 2,000 rpm for a time period within a range from about 5 minutes to about 20 minutes, such as about 10 minutes. The wash and centrifuge steps are repeated as needed to reduce contaminants to desirable levels.

The silver-nickel core-sheath nanostructures contain uniform, smooth nickel coatings. The nickel coatings, such as sheath layer 130, generally have a thickness within a range from about 0.5 nm to about 50 nm, more narrowly within a range from about 1 nm to about 30 nm, more narrowly within a range from about 2 nm to about 20 nm and more narrowly within a range from about 3 nm to about 10 nm, for example, about 5 nm.

### Photovoltaic Cells and Devices Containing Core-Sheath Nanostructures

The core-sheath nanostructures, including core-sheath nanowires 100 (e.g., silver-nickel core-sheath nanowires), as described in embodiments herein may be utilized in transparent conductive materials and films disposed in photovoltaic/solar cells and devices, especially in such cells and devices that contain magnetic core-sheath nanostructures having work-functions to match the photovoltaic materials. The magnetism property of the silver-nickel core-sheath nanowires provide a means for magnetically aligning the silver-nickel core-sheath nanowires relative to themselves within a film in the photovoltaic device. Exemplary photovoltaic cells and devices that contain magnetic core-sheath nanostructures and methods for incorporating magnetic core-sheath nanostructures within photovoltaic cells and devices are further disclosed in the commonly assigned U.S. application Ser. No. 12/766,829, filed Apr. 23, 2010, and published as U.S. Pub. No. 2011/0180133, which is herein incorporated by reference.

In general, embodiments of the invention contemplate a transparent conductive film, layer, or material containing a plurality of multi-metallic core-sheath nanostructures, such as a plurality of core-sheath nanowires 100, that have an optimal combination of both electrical conductivity and optical transparency. The transparent conductive thin film contains a two-dimensional array of the core-sheath nanostructures that are aligned substantially parallel to each other and have axes extending in the plane of the thin film. The transparent conductive thin film utilizes the interconnection of individual core-sheath nanostructures for electrical conductivity whereas the core-sheath nanostructures are configured to provide a plurality of continuous conductive pathways. The optical transparency comes from the low density of metal in the transparent conductive thin film, which is a function of the diameter of the core-sheath nanostructures, as well as the line spacing between the core-sheath nanostructures.

For photovoltaic applications, substantial optical transparency is desired for wavelengths of less than 1.1 μm, since photons with wavelengths of less than 1.1 μm may produce electron-hole pairs in the active layer of a typical photovoltaic device. Therefore, a desirable spacing between adjacent core-sheath nanostructures is within a range from about 50 nm to about 1 μm, which provides continuous conductive pathways throughout the transparent conductive thin film. Such spacing range provides a desirable combination of electrical conductivity and optical transparency for a thin film containing the core-sheath nanostructures.

The optically transparent conductive layer containing a plurality of multi-metallic core-sheath nanostructures, such as a plurality of core-sheath nanowires 100 may have optical transmission of greater than 70% over the wavelength range of 250 nm through 510 nm, and sheet resistance of less than 50Ω, more specifically, an optical transmission of greater than 80% over the wavelength range of 250 nm through 1.1 microns, and sheet resistance less than 20Ω, and more specifically, an optical transmission of greater than 90% over the wavelength range of 250 nm to 1.1 microns, and sheet resistance less than 20Ω at room temperature.

In another embodiment, a method for forming a transparent conductive film, layer, or material containing a plurality of multi-metallic core-sheath nanostructures (e.g., core-sheath nanowires 100) includes the following steps. The multi-metallic core-sheath nanostructures are disposed on the surface of the substrate. In the case of a photovoltaic/solar device, the substrate may be a glass substrate. The substrate may be oriented to provide the substrate surface in a vertical or horizontal position. The deposition step may conveniently include spraying or otherwise applying a liquid suspension of core-sheath nanostructures onto the surface of the substrate. Thereafter, a magnetic field, with field lines parallel to the substrate surface, is applied to the liquid suspension across the substrate surface. The magnetic field is applied by a magnetic source, such as a magnet or a coil, or by multiple magnets and/or coils. The magnetic source is configured so that the magnetic field lines are adjustable to extend along the substrate surface in any position, including vertical or horizontal positions.

In some examples, the alignment of the core-sheath nanostructures to the magnetic field lines may be assisted by orienting the substrate such that the substrate surface is in a vertical plane along the magnetic field. The core-sheath nanostructures are aligned or substantially aligned to the magnetic field which forms the core-sheath nanostructures into a plurality of continuous conductive pathways extending parallel to the magnetic field lines. The arrangement of the core-sheath nanostructures is favored since the formation of continuous lines of the core-sheath nanostructures is a low energy state for the magnetic circuit. Furthermore, having the substrate in a vertical orientation is expected to facilitate the movement of the core-sheath nanostructures which are re-oriented into a lower energy state.

After the deposition and alignment steps, the core-sheath nanostructures may be coated with a conductive material, such as a metallic film or an optically transparent, electrically conductive film. Such coatings may be utilized to affix the core-sheath nanostructures in the desired aligned configuration.

In some examples, the aligned, core-sheath nanostructures may be coated with a conductive metal layer containing gold, silver, copper, alloys thereof, derivatives thereof, or combinations thereof. The conductive metal layer may be plated, deposited, or otherwise formed by electroless plating, electrochemical plating, or a vapor deposition process. In one example, silver-nickel core-sheath nanowires may be immersion coated with silver or gold by a spray process such as electroless nickel immersion gold (ENIG) process or a replacement deposition process.

In other examples, the aligned, core-sheath nanostructures may be coated with an optically transparent, electrically conductive layer, such as a transparent conducting oxide (TCO). The TCO may be sputter deposited directly on top of the aligned, core-sheath nanostructures and will be effective in fixing the core-sheath nanostructures in place in the desired configuration. The TCO may contain indium tin oxide, zinc oxide, derivatives thereof, or combinations thereof. The TCO may also be deposited on the core-sheath nanostructures coated substrate using other deposition methods.

Generally, the upper surface of the substrate is a transparent conductive film which is substantially optically transparent and electrically conductive and the core-sheath nanostructures are disposed thereon. The transparent conductive film may be a TCO film containing a TCO material such as indium tin oxide, zinc oxide, derivatives thereof, or combinations thereof. The transparent conductive film may be deposited or otherwise formed on the substrate surface using a deposition method, such as a sputter deposition process. The oriented core-sheath nanostructures are aligned into a plurality of continuous conductive pathways, as described above and are electrically connected to the transparent conductive film. To help ensure desired electrical contact between the core-sheath nanostructures and the transparent conductive film, surface oxides may be removed from the core-sheath nanostructures prior to deposition on the transparent conductive film using an acid dip or equivalent process.

The integration of the aligned, core-sheath nanostructures and the transparent conductive film provides an electrically conductive, optically transparent layer which has a long range electrical conductivity determined primarily by the properties of the aligned, core-sheath nanostructures and a short range electrical conductivity (on the length scale of the separation between adjacent continuous conductive pathways) determined primarily by the properties of the transparent conductive film. This integrated layer allows for a transparent conductive film with a thickness optimized primarily for optical transparency, since the electrical conductivity is provided primarily by the aligned, core-sheath nanostructures. The transparent conductive film and the layer of the aligned, core-sheath nanostructures are effectively two dimensional structures, therefore, the electrical conductivity of these structures may most conveniently be discussed in terms of sheet resistance. Therefore, the integrated layer is still electrically conductive even if some of the core-sheath nanostructures form disrupted or discontinuous strings. Indeed, short interruptions in the string of the core-sheath nanostructures may then be accommodated by a short current path through the electrically conductive film.

### Experimental Section

Experiment 1—Silver nanowires (about 1×10⁻³ mg, diameter of about 70 nm and length of about 5 μm) were dispersed in about 5 mL of water and heated to about 65° C. for about 10 minutes while magnetically stirring the dispersion. A potassium tetrachloropalladate solution (about 0.2 mM in water) was added dropwise to the silver nanowire dispersion while maintaining a Ag:Pd concentration ratio within a range from about 400:1 to about 400:10 while galvanically replacing Ag atoms with Pd atoms on the surface of the silver nanowires. This galvanic reaction was allowed to proceed for 15 minutes before the Ag—Pd nanowires were separated from the aqueous solution by filtration. Thereafter, the Ag—Pd nanowires were washed in a mixture of ethanol and water and centrifuged at about 2,500 rpm for about 10 minutes to remove unreacted precursors.

The Ag—Pd nanowires were dispersed in about 5.5 mL of ethylene glycol (EG) and heated to about 65° C. for about 10 minutes while magnetically stirring the dispersion. A nickel salt solution (about 17 mM of nickel acetate tetrahydrate and about 94 mM poly(vinylpyrrolidone) (PVP)) was added dropwise to the Ag—Pd nanowire dispersion while maintaining a Ag:Ni concentration ratio within the range from about 400:200 to about 400:300 during the nickel coating process. Immediately following the addition of the nickel salt solution, about 0.40 mL of a hydrazine solution (hydrazine monohydrate in EG at a volume ratio of hydrazine monohydrate:EG of about 1:9) was added dropwise to the dispersion. After adding all of the hydrazine solution to the dispersion, the reaction mixture was stirred for about 20 minutes while uniform, smooth nickel coatings formed over the Ag—Pd nanowires to produce the Ag—Ni core-sheath nanowires contained within the remaining reaction solution.

The Ag—Ni core-sheath nanowires were separated from the reaction solution, washed in acetone and centrifuged at about 2,500 rpm for about 10 minutes, then washed in water and centrifuged at about 2,000 rpm for about 10 minutes, and again washed in water and centrifuged at about 2,000 rpm for about 10 minutes.

Experiment 2—Silver nanowires (about 1×10⁻³ mg, diameter of about 70 nm and length of about 5 μm) were dispersed in about 5 mL of water and heated to about 95° C. for about 5 minutes while magnetically stirring the dispersion. A potassium tetrachloropalladate solution (about 0.2 mM in water) was added dropwise to the silver nanowire dispersion while maintaining a Ag:Pd concentration ratio within a range from about 400:1 to about 400:10 while galvanically replacing Ag atoms with Pd atoms on the surface of the silver nanowires. This galvanic reaction was allowed to proceed for 15 minutes before the Ag—Pd nanowires were separated from the aqueous solution by filtration. Thereafter, the Ag—Pd nanowires were washed in a mixture of ethanol and water and centrifuged at about 2,500 rpm for about 10 minutes to remove unreacted precursors.

The Ag—Pd nanowires were dispersed in about 5.5 mL of EG and heated to about 95° C. for about 5 minutes while magnetically stirring the dispersion. A nickel salt solution (about 17 mM of nickel acetate tetrahydrate and about 94 mM PVP) was added dropwise to the Ag—Pd nanowire dispersion while maintaining a Ag:Ni concentration ratio within the range from about 400:200 to about 400:300 during the nickel coating process. Immediately following the addition of the nickel salt solution, about 0.40 mL of a hydrazine solution (hydrazine monohydrate in EG at a volume ratio of hydrazine monohydrate:EG of about 1:9) was added dropwise to the dispersion. After adding all of the hydrazine solution to the dispersion, the reaction mixture was stirred for about 20 minutes while uniform, smooth nickel coatings formed over the Ag—Pd nanowires to produce the Ag—Ni core-sheath nanowires contained within the remaining reaction solution.

The Ag—Ni core-sheath nanowires were separated from the reaction solution, washed in acetone and centrifuged at about 2,500 rpm for about 10 minutes, then washed in water and centrifuged at about 2,000 rpm for about 10 minutes, and again washed in water and centrifuged at about 2,000 rpm for about 10 minutes.

Experiment 3—Silver nanowires (about 1×10⁻³ mg, diameter of about 70 nm and length of about 5 μm) were dispersed in about 5 mL of water and heated to about 65° C. for about 10 minutes while magnetically stirring the dispersion. A potassium tetrachloroplatinate solution (about 0.2 mM in water) was added dropwise to the silver nanowire dispersion while maintaining a Ag:Pt concentration ratio within a range from about 400:1 to about 400:10 while galvanically replacing Ag atoms with Pt atoms on the surface of the silver nanowires. This galvanic reaction was allowed to proceed for about 15 minutes before the Ag—Pt nanowires were separated from the aqueous solution by filtration. Thereafter, the Ag—Pt nanowires were washed in a mixture of ethanol and water and centrifuged at about 2,500 rpm for about 10 minutes to remove unreacted precursors.

The Ag—Pt nanowires were dispersed in about 5.5 mL of EG and heated to about 65° C. for about 10 minutes while magnetically stirring the dispersion. A nickel salt solution (about 17 mM of nickel acetate tetrahydrate and about 94 mM PVP) was added dropwise to the Ag—Pt nanowire dispersion while maintaining a Ag:Ni concentration ratio within the range from about 400:200 to about 400:300 during the nickel coating process. Immediately following the addition of the nickel salt solution, about 0.40 mL of a hydrazine solution (hydrazine monohydrate in EG at a volume ratio of hydrazine monohydrate:EG of about 1:9) was added dropwise to the dispersion. After adding all of the hydrazine solution to the dispersion, the reaction mixture was stirred for about 20 minutes while uniform, smooth nickel coatings formed over the Ag—Pt nanowires to produce the Ag—Ni core-sheath nanowires contained within the remaining reaction solution.

The Ag—Ni core-sheath nanowires were separated from the reaction solution, washed in acetone and centrifuged at about 2,500 rpm for about 10 minutes, then washed in water and centrifuged at about 2,000 rpm for about 10 minutes, and again washed in water and centrifuged at about 2,000 rpm for about 10 minutes.

Experiment 4—Silver nanowires (about 1×10⁻³ mg, diameter of about 70 nm and length of about 5 μm) were dispersed in about 5 mL of water and heated to about 95° C. for about 5 minutes while magnetically stirring the dispersion. A potassium tetrachloroplatinate solution (about 0.2 mM in water) was added dropwise to the silver nanowire dispersion while maintaining a Ag:Pt concentration ratio within a range from about 400:1 to about 400:10 while galvanically replacing Ag atoms with Pt atoms on the surface of the silver nanowires. This galvanic reaction was allowed to proceed for about 15 minutes before the Ag—Pt nanowires were separated from the aqueous solution by filtration. Thereafter, the Ag—Pt nanowires were washed in a mixture of ethanol and water and centrifuged at about 2,500 rpm for about 10 minutes to remove unreacted precursors.

The Ag—Pt nanowires were dispersed in about 5.5 mL of EG and heated to about 95° C. for about 5 minutes while magnetically stirring the dispersion. A nickel salt solution (about 17 mM of nickel acetate tetrahydrate and about 94 mM PVP) was added dropwise to the Ag—Pt nanowire dispersion while maintaining a Ag:Ni concentration ratio within the range from about 400:200 to about 400:300 during the nickel coating process. Immediately following the addition of the nickel salt solution, about 0.40 mL of a hydrazine solution (hydrazine monohydrate in EG at a volume ratio of hydrazine monohydrate:EG of about 1:9) was added dropwise to the dispersion. After adding all of the hydrazine solution to the dispersion, the reaction mixture was stirred for about 20 minutes while uniform, smooth nickel coatings formed over the Ag—Pt nanowires to produce the Ag—Ni core-sheath nanowires contained within the remaining reaction solution.

The Ag—Ni core-sheath nanowires were separated from the reaction solution, washed in acetone and centrifuged at about 2,500 rpm for about 10 minutes, then washed in water and centrifuged at about 2,000 rpm for about 10 minutes, and again washed in water and centrifuged at about 2,000 rpm for about 10 minutes.

Experiment 5—Silver nanowires (about 1×10⁻³ mg, diameter of about 70 nm and length of about 5 μm) were dispersed in about 5 mL of water and heated to about 100° C. for about 10 minutes while magnetically stirring the dispersion. A chloroauric acid (HAuCl₄) solution (about 0.3 mM in water) was added dropwise to the silver nanowire dispersion to galvanically replace Ag atoms with Au atoms on the surface of the silver nanowires. This galvanic reaction was allowed to proceed for about 15 minutes before the Ag—Au nanowires were separated from the aqueous solution by filtration. Thereafter, the Ag—Au nanowires were washed in a mixture of ethanol and water and centrifuged at about 2,500 rpm for about 10 minutes to remove unreacted precursors.

The Ag—Au nanowires were dispersed in about 5.5 mL of EG and heated to about 65° C. for about 10 minutes while magnetically stirring the dispersion. A nickel salt solution (about 17 mM of nickel acetate tetrahydrate and about 94 mM PVP) was added dropwise to the Ag—Au nanowire dispersion while maintaining a Ag:Ni concentration ratio within the range from about 400:200 to about 400:300 during the nickel coating process. Immediately following the addition of the nickel salt solution, about 0.40 mL of a hydrazine solution (hydrazine monohydrate in EG at a volume ratio of hydrazine monohydrate:EG of about 1:9) was added dropwise to the dispersion. After adding all of the hydrazine solution to the dispersion, the reaction mixture was stirred for about 20 minutes while uniform, smooth nickel coatings formed over the Ag—Au nanowires to produce the Ag—Ni core-sheath nanowires contained within the remaining reaction solution.

The Ag—Ni core-sheath nanowires were separated from the reaction solution, washed in acetone and centrifuged at about 2,500 rpm for about 10 minutes, then washed in water and centrifuged at about 2,000 rpm for about 10 minutes, and again washed in water and centrifuged at about 2,000 rpm for about 10 minutes.

### Exemplary Core-Sheath Nanostructures

In one embodiment, the core-sheath nanostructures are a plurality of core-sheath nanowires. Each of the core-sheath nanowires has a nanowire core, a catalytic metal layer disposed on the nanowire core, and a sheath layer disposed on and/or over and encompassing the catalytic metal layer and the nanowire core. The nanowire core contains metallic silver or a silver alloy. The catalytic metal layer contains metallic palladium, metallic platinum, metallic gold, alloys thereof, doped variations thereof, derivatives thereof, or combinations thereof. The sheath layer contains metallic nickel, metallic cobalt, metallic iron, alloys thereof, doped variations thereof, derivatives thereof, or combinations thereof.

In some examples, the core-sheath nanowires are a plurality of silver-nickel core-sheath nanowires which have a nanowire core containing metallic silver or a silver alloy, a catalytic metal layer containing metallic palladium or a palladium alloy, and a sheath layer containing metallic nickel or a nickel alloy. The nanowire core has a width or a diameter within a range from about 50 nm to about 100 nm, such as about 70 nm and a length within a range from about 500 nm to about 1,000 nm, such as about 750 nm. The sheath layer has a thickness within a range from about 3 nm to about 10 nm, such as about 5 nm. Therefore, each of the silver-nickel core-sheath nanowires has a total width or a total diameter within a range from about 60 nm to about 100 nm, such as about 75 nm and a length within a range from about 500 nm to about 1,000 nm, such as about 750 nm. In other examples, the nanowire core has a much longer length, so that the silver-nickel core-sheath nanowires has a total length within a range from about 2,000 nm to about 8,000 nm, such as about 5,000 nm.

While the foregoing is directed to embodiments of the invention, other and further embodiments of the invention may be devised without departing from the basic scope thereof, and the scope thereof is determined by the claims that follow.

1. A method for forming core-sheath nanostructures, comprising:
stirring an aqueous dispersion comprising silver nanostructures while adding a catalytic metal salt solution to the aqueous dispersion and forming catalytic metal coated silver nanostructures during a galvanic replacement process;
removing the catalytic metal coated silver nanostructures from the aqueous dispersion;
forming an organic solvent dispersion comprising the catalytic metal coated silver nanostructures dispersed in an organic solvent;
stirring the organic solvent dispersion while adding a nickel salt solution to the organic solvent dispersion;
adding a reducing solution to the organic solvent dispersion comprising the nickel salt solution to form silver-nickel core-sheath nanostructures during a nickel coating process; and
separating the silver-nickel core-sheath nanostructures from the organic solvent dispersion.

2. The method of claim 1, wherein each of the catalytic metal coated silver nanostructures has a catalytic metal layer comprising a metal selected from the group consisting of palladium, platinum, gold, alloys thereof, and combinations thereof.

3. The method of claim 2, wherein the catalytic metal salt solution comprises a tetrachloroplatinate salt or a tetrachloropalladate salt.

4. The method of claim 2, wherein the catalytic metal salt solution is added to the aqueous dispersion at a rate to maintain a Ag:Pd concentration ratio or a Ag:Pt concentration ratio of the aqueous dispersion within a range from about 400:1 to about 400:25 during the galvanic replacement process.

5. The method of claim 4, wherein the rate to maintain a Ag:Pd concentration ratio or a Ag:Pt concentration ratio of the aqueous dispersion is within a range from about 400:1 to about 400:10 during the galvanic replacement process.

6. The method of claim 1, wherein the nickel salt solution comprises poly(vinylpyrrolidone).

7. The method of claim 6, wherein the nickel salt solution further comprises a nickel acetate salt.

8. The method of claim 1, wherein the nickel salt solution is added to the organic solvent dispersion at a rate to maintain a Ag:Ni concentration ratio of the organic solvent dispersion within a range from about 400:200 to about 400:300 during the nickel coating process.

9. The method of claim 1, wherein the reducing solution comprises hydrazine and a glycol.

10. The method of claim 1, wherein the organic solvent comprises a glycol.

11. The method of claim 1, wherein the silver nanostructures are nanowires comprising metallic silver, and each nanowire has a diameter within a range from about 5 nm to about 500 nm.

12. A method for forming core-sheath nanowires, comprising:
stirring an aqueous dispersion comprising silver nanowires while adding a palladium salt solution to the aqueous dispersion and forming palladium coated silver nanowires during a galvanic replacement process;
removing the palladium coated silver nanowires from the aqueous dispersion;
forming an organic solvent dispersion comprising the palladium coated silver nanowires dispersed in an organic solvent;
stirring the organic solvent dispersion while adding a nickel salt solution to the organic solvent dispersion;
adding a reducing solution to the organic solvent dispersion comprising the nickel salt solution to form silver-nickel core-sheath nanowires during a nickel coating process; and
separating the silver-nickel core-sheath nanowires from the organic solvent dispersion.

13. The method of claim 12, wherein the palladium salt solution is added to the aqueous dispersion at a rate to maintain a Ag:Pd concentration ratio of the aqueous dispersion within a range from about 400:1 to about 400:25 during the galvanic replacement process.

14. The method of claim 13, wherein the rate to maintain a Ag:Pd concentration ratio of the aqueous dispersion is within a range from about 400:1 to about 400:10 during the galvanic replacement process.

15. The method of claim 12, wherein the organic solvent comprises a glycol and the nickel salt solution comprises poly(vinylpyrrolidone) and a nickel acetate salt.

16. The method of claim 12, wherein the nickel salt solution is added to the organic solvent dispersion at a rate to maintain a Ag:Ni concentration ratio of the organic solvent dispersion within a range from about 400:200 to about 400:300 during the nickel coating process.

17. The method of claim 12, wherein the reducing solution comprises hydrazine and a glycol.

18. The method of claim 12, wherein each of the silver nanowires has a diameter within a range from about 5 nm to about 500 nm.

19. A core-sheath nanowire, comprising:
a nanowire core having a diameter within a range from about 5 nm to about 500 nm and comprising metallic silver;
a catalytic metal layer disposed on the nanowire core and comprising at least one metal selected from the group consisting of palladium, platinum, gold, alloys thereof, and combinations thereof; and
a sheath layer disposed over and encompassing the catalytic metal layer and the nanowire core and comprising at least one metal selected from the group consisting of nickel, cobalt, iron, alloys thereof, and combinations thereof.

20. The core-sheath nanowire of claim 19, wherein the catalytic metal layer comprises metallic palladium or metallic platinum and the sheath layer comprises metallic nickel.
